(19) United States
(12) Patent Application Publication
(10) Pub. No.: US 2018/0055112 A1
(43) Pub. Date: Mar. 1, 2018

(54) SOLVENT RESISTANT COMPOSITE FILM

(71) Applicant: KIMBERLY-CLARK WORLDWIDE, INC., Neenah, WI (US)

(72) Inventors: Alphonse Carl DeMarco, Greenville, WI (US); Gregory James Wideman, Menasha, WI (US); Hubert Stankiewicz, Woodstock, GA (US)

(21) Appl. No.: 15/558,289

(22) PCT Filed: Feb. 23, 2016
(86) PCT No.: PCT/US16/19134

§ 371 Date: Sep. 14, 2017

Related U.S. Application Data
(60) Provisional application No. 62/136,158, filed on Mar. 20, 2015.

(51) Int. Cl. A41D 19/00; B32B 27/30; B32B 27/32; B32B 27/40; C08J 5/18; C08K 3/34

(52) U.S. Cl. CPC A41D 19/0068; B32B 27/30; B32B 27/32; B32B 27/40; C08J 5/18; C08K 2201/005; C08K 3/34; A41D 2400/80; A41D 2400/44; B32B 2437/02; C08J 2329/04; C08K 3/346

(57) ABSTRACT

A composite film includes a composite blend layer including a water-soluble synthetic thermoplastic polymer and blocking particles, wherein the blocking particles are nanoclay particles or talc particles, and wherein the composite film is free of compatibilizers. In addition, a laminate film consists of two layers, wherein the first layer is a composite blend layer including polyvinyl alcohol (PVOH) and blocking particles, wherein the blocking particles are nanoclay particles or talc particles, and wherein the second layer is a polyolefin film layer in facing relationship with the composite blend layer, wherein the laminate is free of compatibilizers. These films can be used to manufacture a glove or other article for solvent resistance.

### BACKGROUND

Articles such as gloves are often formed from synthetic polymers. Unfortunately, one problem sometimes associated with the formation of polymeric articles from some types of synthetic polymers is that they tend to allow vapors to pass therethrough when contacted with certain chemicals or solvents. This effect of the polymer can be especially problematic when used in certain fields, such as in the aviation, medical, and automotive field.

As such, a need currently exists for improved composites and articles that are relatively resistant to various types of chemicals or solvents.

### SUMMARY

The present disclosure is generally directed to a composite film including a composite blend layer including a water-soluble synthetic thermoplastic polymer and blocking particles, wherein the blocking particles are nanoclay particles or talc particles, and wherein the composite film is free of compatibilizers.

The present disclosure is also directed to a laminate film consisting of two layers, wherein the first layer is a composite blend layer including polyvinyl alcohol (PVOH) and blocking particles, wherein the blocking particles are nanoclay particles or talc particles, and wherein the second layer is a polyolefin film layer in facing relationship with the composite blend layer, wherein the laminate is free of compatibilizers.

The present disclosure is also directed to a solvent-resistant glove including a composite film, the composite film including a composite blend layer including PVOH and blocking particles, wherein the blocking particles are nanoclay particles or talc particles; and a polyolefin film layer in facing relationship with the composite blend layer to form a laminate film, wherein the laminate film is free of compatibilizers.

Other features and aspects of the present disclosure are discussed in greater detail herein.

### BRIEF DESCRIPTION OF THE DRAWINGS

The present disclosure will be more fully understood, and further features will become apparent, when reference is made to the following detailed description and the accompanying drawings. The drawings are merely representative and are not intended to limit the scope of the claims.

FIG. 1 is a perspective view of one aspect of a glove made according to the present disclosure; and

FIG. 2 is a cutaway cross-section view of the glove of FIG. 1, taken along the 2-2 line of FIG. 1, including optional inner and outer layers.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

It is to be understood by one of ordinary skill in the art that the present discussion is a description of exemplary aspects only, and is not intended as limiting the broader aspects of the present disclosure.

The present disclosure is generally directed to an article that includes a chemical protection layer that will not substantially dissolve and will reduce the rate of permeation of solvent vapor therethrough when contacted with certain chemicals or solvents.

Any of a variety of articles can be provided with improved chemical resistance properties in accordance with the present disclosure. For example, gloves, medical devices, containers, liners, and the like, can be formed according to the present disclosure. In addition, it should also be understood that other types of articles can also be formed according to the present disclosure.

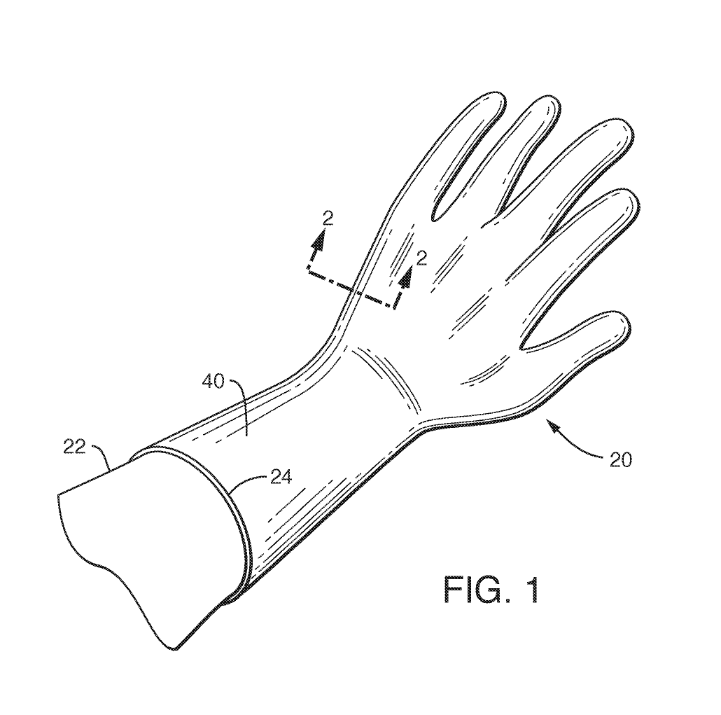

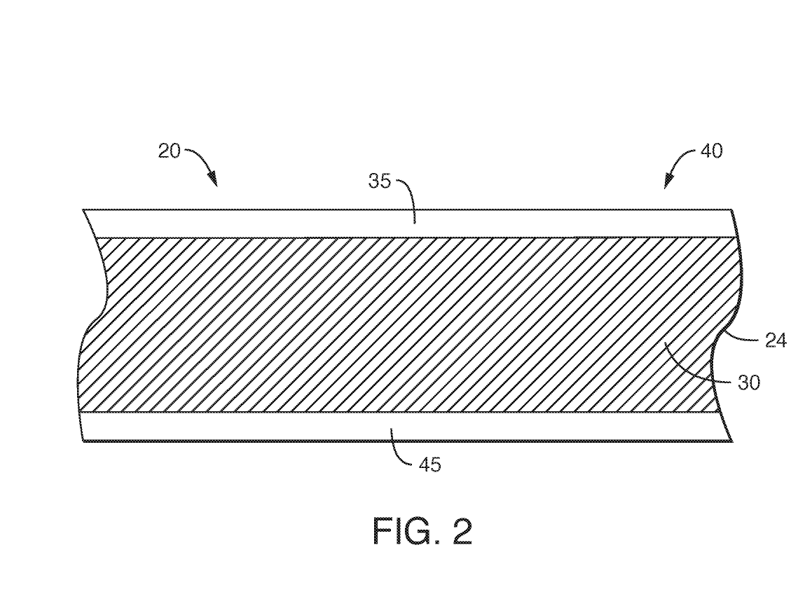

Referring to FIGS. 1 and 2, for example, one aspect of the present disclosure is a glove 20 that can be placed on the hand of a user 22. The glove 20 includes a composite film 24 having the basic shape of the glove. The composite film 24 can generally be formed from any of the materials described herein.

There is a need in industries such as the aviation industry for hand protection against harsh solvents such as MEK (methyl ethyl ketone), MPK (methyl propyl ketone), SKYDROL aviation hydraulic fluid, trichloroethane, citrus cleaner degreaser, naphtha solvent, and oil and grease cleaners that do not compromise comfort, productivity, and do not add significant cost. Specific areas of focus can be on engines, fuel lines, and paint process use of solvents. Various methods of working with ketone type solvents are currently employed that might not be optimal. Methods include: (1) wearing a cotton glove with a nitrile glove over it requires changing the nitrile gloves every 30 minutes because the nitrile glove is not made to hold out ketones; (2) not wearing gloves because a user is not aware of the chronic hazards of the solvents, and acute hazards might not be severe; (3) wearing a PVOH (polyvinyl alcohol)-supported glove that is expensive (˜$US 36/pair) and has poor dexterity; (4) wearing an all-purpose chemical glove that is film based but not very dexterous.

The concept described herein provides the protection of bulky PVOH gloves with the dexterity of a thin mil glove. End users can wear their gloves longer to stay at their tasks until completion. The users can be more efficient in their tasks without having to change gloves multiple times and be exposed to chemicals. Value is captured by improving productivity and reducing exposure to hazards.

Polyvinyl alcohol is resistant to MEK, for example, if the film is thick enough, on the order of 8 mils. The problem, however, is that a thick glove does not provide the needed dexterity. In addition, PVOH is soluble in water and softens upon contact with water. In one exemplary aspect, the addition of nanoclay particles in the 10-15 μm particle size range can reduce the transmission of MEK through the polyvinyl alcohol film at significantly lower thickness (1-3 mils). The addition of nanoclay particles allows the thickness of the PVOH film to be reduced and therefore make for a more dexterous glove. The time of MEK breakthrough can be controlled through the amount of nanoclay and the thickness of the final film. It is important to note that this improvement in resistance does not require the use of a compatibilizer in the composite.

The water-dispersible, thermoplastic composition includes one or more polymers containing a repeating unit having a functional hydroxyl group, such as polyvinyl alcohol (“PVOH”). Vinyl alcohol polymers, for instance, have at least two or more vinyl alcohol units in the molecule and may be a homopolymer of vinyl alcohol, or a copolymer containing other monomer units. Vinyl alcohol homopolymers may be obtained by hydrolysis of a vinyl ester polymer, such as vinyl formate, vinyl acetate, vinyl propionate, etc. Vinyl alcohol copolymers may be obtained by hydrolysis of a copolymer of a vinyl ester with an olefin having 2 to 30 carbon atoms, such as ethylene, propylene, 1-butene, etc.; an unsaturated carboxylic acid having 3 to 30 carbon atoms, such as acrylic acid, methacrylic acid, crotonic acid, maleic acid, fumaric acid, etc., or an ester, salt, anhydride or amide thereof; an unsaturated nitrile having 3 to 30 carbon atoms, such as acrylonitrile, methacrylonitrile, etc.; a vinyl ether having 3 to 30 carbon atoms, such as methyl vinyl ether, ethyl vinyl ether, etc.; and so forth. The degree of hydrolysis may be selected to optimize solubility, etc., of the polymer. For example, the degree of hydrolysis may be from about 60 mole % to about 95 mole %, in some embodiments from about 80 mole % to about 90 mole %, and in some embodiments, from about 85 mole % to about 89 mole %, and in some embodiments from about 87 mole % to about 89 mole %. These partially hydrolyzed polyvinyl alcohols are cold water soluble. In contrast, the completely hydrolyzed or nearly hydrolyzed polyvinyl alcohols are not soluble in cold water.

Nanoclays are particularly suitable for use in the present disclosure. The term “nanoclay” generally refers to nanoparticles of a clay material (a naturally occurring mineral, an organically modified mineral, or a synthetic nanomaterial). The clay material typically has a flake-like morphology in that it possesses a relatively flat or platelet shape. The clay platelets may, for example, have an average thickness of from about 0.2 to about 100 nanometers, in some embodiments from about 0.5 to about 50 nanometers, and in some embodiments, from about 1 to about 20 nanometers. The “aspect ratio” of the clay material (i.e., the average length of the platelets divided by the average thickness) is also relatively large, such as from about 20 to about 1000, in some embodiments from about 50 to about 80, in some embodiments, from about 100 to about 400. The average length (e.g., diameter) may, for instance, range from about 20 nanometers to about 10 micrometers, in some embodiments from about 100 nanometers to about 5 micrometers, and in some embodiments, from about 200 nanometers to about 4 micrometers.

The nanoclay material may be formed from a phyllosilicate, such as a smectite clay mineral (e.g., bentonite, kaolinite, or montmorillonite, as well as salts thereof, such as sodium montmorillonite, magnesium montmorillonite, calcium montmorillonite, etc.); nontronite; beidellite; volkonskoite; hectorite; saponite; sauconite; sobockite; stevensite; svinfordite; vermiculite; etc. Other useful nanoclays include micaceous minerals (e.g., illite) and mixed illite/smectite minerals, such as rectorite, tarosovite, ledikite and admixtures of illites with the clay minerals named above. Particularly suitable are montmorillonite (2:1 layered smectite clay structure), bentonite (aluminum phyllosilicate formed primarily of montmorillonite), kaolinite (1:1 aluminosilicate having a platy structure and empirical formula of Al2Si2O5(OH)4), halloysite (1:1 aluminosilicate having a tubular structure and empirical formula of Al2Si2O5(OH)4), etc.

A solvent-resistant article 20 of the present disclosure includes a composite film 24. The composite film 24 includes a water-soluble synthetic thermoplastic polymer and blocking particles 30, where the blocking particles 30 can be nanoclay, talc, or both. The water-soluble synthetic thermoplastic polymer can be PVOH, which can be partially hydrolyzed, fully hydrolyzed, or a blend of both. The composite film 24 is free of compatibilizers.

The blocking particles 30 in the composite film 24 can be nanoclay particles, talc particles, or both. Nanoclay particles can be of any suitable size, and preferably have a particle size of 10 to 15 microns. Talc particles can be of any suitable size, and preferably have a particle size of 3 to 10 microns.

To increase the water resistance of the composite film 24, a polyolefin film layer can be added as an outer layer 35 in facing relationship with the composite film 24 to form a film laminate 40, as illustrated in FIG. 2. The outer layer 35 is an optional addition to the composite film 24. Increasing the water resistance is particularly important if the composite film 24 is to be used in articles such as gloves. A multilayered approach can include two or more layers. An outer layer 35 can be a polyolefin such as polypropylene or polyethylene to provide some solvent resistance, but primarily providing a barrier for water, protecting the water-soluble PVOH composite film 24. The outer layer 35 protects the composite film 24 described herein. An inner layer 45 can be a polyolefin, such as polyethylene or a thermoplastic polyurethane. This inner layer 45 can also include additives to promote ease of donning. The inner layer 45 protects the composite film 24 from water, such as from perspiration.

These inner and outer layers 45, 35 can be added to the composite film 24 with or without the use of tie layers. Using inner and outer layers 45, 35 can create separate benefits to either side of the composite film 24, particularly if the film laminate 40 is formed into an article 20 such as a glove. The inner layer 45 can be prepared to provide improved donning characteristics and/or benefits with the incorporation of donning aid, lubricants, etc. without affecting the solvent resistance. The outer layer 35 can be adjusted for the required grip and antiblocking properties. The outer layer 35 can also be varied to provide protection from aqueous solutions or chemicals as well as to improve resistance to chemicals and chemical vapors to which PVOH is permeable.

The inner layer 45, when tailored for donning, can be a low density polyethylene, polyolefin, or thermoplastic polyurethane that provides the required coefficient of friction to allow for easy donning by the user. The inner layer 45 also prevents hand perspiration from reaching and affecting the PVOH in the composite film 24. The inner layer 40 can also include suitable additives to promote donning. The glove 20 can have an interior surface having an interior surface additive such as a slip agent, calcium carbonate, or talc.

The outer layer 35 can be a low crystallinity polypropylene, polyethylene, or polyolefin that both provides resistance to ketones and protects the inner polyvinyl alcohol from aqueous environments. The material of the outer layer 35 can also be elastic to provide good fit and dexterity. The outer layer 35 can include one or more of an embossed surface, calcium carbonate, and talc.

The composite film 24 or the multilayered laminate film 40 can be produced by sheet extrusion, blown film extrusion, or by any other suitable method. To form an article 20 such as a glove, two sheets of the composite film 24 or the laminate film 40 can be simultaneously seamed and cut to shape. In various aspects, the article 20 can be manufactured by any suitable process, including that described in U.S. Patent Publication No. US 2013/0104286, which is incorporated herein by reference to the extent it does not conflict herewith. This provides a thin mil glove with good dexterity that is resistant to aqueous solutions as well as harsh solvents and be produced at a low cost.

Although a batch process is described and shown herein, it should be understood that semibatch and continuous processes can also be used in the present disclosure.

Although various constructions and techniques for forming articles 20 have been described above, it should be understood that the present disclosure is not limited to any particular construction or technique for forming the article 20. For example, the layers described above might not be used in all instances. Additionally, other layers not specifically referred to above can be used in the present disclosure. Furthermore, the present disclosure is also not limited to any particular type of article 20. For instance, flexible automotive hoses and the like can all be formed in accordance with the present disclosure with improved chemical resistance.

The present disclosure might be better understood with reference to the following examples.

### EXAMPLES

### Materials:

1. Polyvinyl Alcohol: SELVOL 205 partially-hydrolyzed polyvinyl alcohol (PVOH) from Sekisui, Dallas, Tex.
2. Polyvinyl Alcohol: SELVOL 107 fully-hydrolyzed PVOH from Sekisui, Dallas, Tex.
3. NANOMAX polyolefin masterbatch: polypropylene (PP) and low density polyethylene (LDPE) from Nanocor, Hoffman Estates, Ill.
4. Clay particles: NANOMER I.34TCN clay particles from Nanocor, Hoffman Estates, Ill.
5. Talc particles: JETFIL P500 talc particles from IMERYS Talc, San Jose, Calif.
6. Glycerin: plasticizer from Cognis Corporation, Cincinnati, Ohio

### Masterbatch Compounding:

In general, formulated masterbatch resins were produced on a ZSK-30 co-rotating twin screw extruder with 7 heated sections and a resin compounding screw design. Resins were produced at a rate of 20 pounds per hour. Powder or pellet resin was fed through the main feed section. Glycerin was injected in section 3. Nanoclay or talc powder was side fed into section 4 of the extruder. The temperature profile per section, beginning at the main feed section was 90°, 160°, 190°, 195°, 190°, 180°, and 180° C. The melt pressure ranged between 30-50 psi with the extruder torque of between 35 to 45%. The extruded polymer was brown in color with nanoclay and white in color with talc. Both materials flowed well from the die. The strands were air cooled and pelletized.

### Resin Compounding and Film Formation:

Small scale compounded blends were produced on a 16 mm Prism co-rotating twin screw extruder with 10 heated sections and a resin compounding screw design. Resins were produced at a rate of 2 pounds per hour. All resin formulations discussed here were dry blended prior to feeding through the main feed section using a single feeder. The temperature profile per section, beginning at the main feed section were 90°, 160°, 170°, 180°, 180°, 190°, 190°, 190°, 180°, 180°, and 180°. Screw speed was held constant at 200 rpm for all resins. The melt pressure ranged between 10-30 psi with the extruder torque of between 30 to 60%. The extruded polymer was fed into an eight-inch film die with the die gap set at 0.02 inches. The resulting thin film was collected with the chill roll set at 10° C. and a take-up speed of 350 that resulted in a film thickness of between 2 and 3 mils (0.002 to 0.003 inches).

A Haake Rheomex single screw extruder was used to produce mono-layer films for testing properties of formulated resins. The cast films were made using a temperature profile of 180° C., 210° C., 210° C., to 185° C. at the die. The screw speed was 60 rpm. To produce a 1 mil film the chill roll speed was set between 250 and 280 rpm.

### Permeation Testing:

Testing was performed according to EN 374-3:2003 by SGS India Pvt. Ltd. In addition, a simple test for permeation of a substance through a glove material is called a swell test. In this test, a pre-weighed piece of test material is placed in the solvent of interest for a given length of time. The material is then removed from the test solvent, blotted dry, and weighed. This test was used to screen possible film candidates.

Samples were made with polyvinyl alcohol (PVOH) and up to 15% clay. The sample with 15% clay in a 0.063 mm thick film had methyl ethyl ketone (MEK) solvent resistance performance similar to a PVOH film (no clay) that was 0.263 mm thick. Some samples have been made with polyethylene and polypropylene, but at lower levels of clay addition. These also performed better than control samples, but not as well as with PVOH. PVOH-nanoclay composite films were tested against target chemicals used in the aviation industry. Results are presented in Table 1 for laminate film that was plasticized PVOH with 15% nanoclay.

TABLE 1
PVOH-Nanoclay Film Resistance to Various Solvents

| | EN 374-3:2003 - MEK | | | | |
|---|---|---|---|---|---|
| | | Break | | | |
| | Thickness | Through | Permeation | | Notes |
| Test Solvent | mm | min | μg/cm²/min | Class | Swollen |
| MEK | 0.06 | >480 | <1 | 6 | None |
| Skydrol | 0.08 | >480 | ND | 6 | None |
| Isopropyl Alcohol | 0.08 | 21 | ND | 1 | Slightly |
| Diestone DLS | 0.08 | 36 | ND | 2 | Slightly |
| Trichloroethylene | 0.08 | >480 | ND | 6 | None |
| Acetone | 0.08 | 4 | ND | 0 | Slightly |
| Frekote | 0.08 | 6 | ND | 0 | Slightly |
| Xylene | 0.08 | >480 | ND | 6 | None |
| Paint Thinner | 0.08 | 4 | ND | 0 | Slightly |
| MPK | 0.08 | >480 | ND | 6 | None |

Results are presented in Table 2 for permeation through laminate film that was plasticized PVOH with varying levels of nanoclay.

TABLE 2
MEK Permeation in Nanoclay-PVOH Composites

| | EN 374-3:2003 | | | | | | |
|---|---|---|---|---|---|---|---|
| | | | | | Perme- | | |
| | | | | | ation | | |
| | | | | | Rate | | |
| | | | Break | | Steady | | |
| | | | Through | | State | Perfor- | |
| | Thickness | | Time | | Rate | mance | |
| | mm | | Min | | μg/cm²/ | Level | |
| Material | Avg | sd | Avg | sd | min | Class | Notes |
| KCD 1301 | 0.263 | 0.012 | >480 | | <1 | Class 6 | No Change |
| 0% Clay | | | | | | | |
| KCD 1301 | 0.067 | 0.006 | 65 | 3 | 39 | Class 3 | Slightly |
| 5% Clay | | | | | | | Swollen |
| KCD 1301 | 0.063 | 0.006 | 79 | 1 | 24 | Class 3 | Slightly |
| 10% Clay | | | | | | | Swollen |
| KCD 1301 | 0.063 | 0.006 | >480 | | <1 | Class 6 | No Change |
| 15% Clay | | | | | | | |

As demonstrated in Table 3, talc showed the same improvement in resistance for PVOH film as nanoclay. Doubling film thickness improved breakthrough time from 8 minutes to greater than 480 minutes. The addition of talc improved MEK resistance in polyolefin and TPE films, but not to the same degree as in PVOH films.

TABLE 3
MEK Permeation in Talc Fortified Films

| | EN 374-3:2003 - MEK | | | | |
|---|---|---|---|---|---|
| | | | | | Film |
| | | Break | | | Appearance |
| | Thickness | Through | Permeation | | (Degree |
| Material | mm | min | μg/cm²/min | Class | Swollen) |
| PVOH alone | 0.26 | >480 | <1 | 6 | None |
| PVOH - | 0.04 | 8 | ND | 0 | Slightly |
| 15% Talc | | | | | |
| PVOH - | 0.10 | >480 | ND | 6 | Slightly |
| 15% Talc | | | | | |

### CONCLUSION

PVOH with nanoclay exceeded the permeation standard on 5 of the 10 chemicals tested. PVOH with talc further improved the breakthrough time against acetone from 4 minutes to 338 minutes and was rated as Class-5 glove for acetone. The addition of nanoclay or talc improves the solvent resistance of PVOH films. With the addition of 15% of nanoclay or talc, the thickness of PVOH films can be reduced to less than 0.08 mm for nanoclay and to 0.1 mm for talc and have the same resistance as a 0.26 mm PVOH film without additives.

The theory behind this disclosure is that the nanoclay and/or talc particles are providing a torturous path for the solvent vapors, making it difficult for the solvent vapors to pass through the thinner film barrier.

The addition of nanoclay and/or talc particles does not require the inclusion of a compatibilizer to defoliate the particles to achieve the desired resistance to MEK vapor breakthrough.

Further improvement can be accomplished by using the PVOH as the core layer of a multilayered film structure. This technology can be applied to other polyolefins and thermoplastic elastomers, although higher levels of additive or thicker films might be required to achieve equivalent results to PVOH composite films.

The ability of an article to be imparted with chemical resistance in accordance with the present disclosure was demonstrated.

In a first particular aspect, a composite film includes a composite blend layer including a water-soluble synthetic thermoplastic polymer and blocking particles, wherein the blocking particles are nanoclay particles or talc particles, and wherein the composite film is free of compatibilizers.

A second particular aspect includes the first particular aspect, further including a polyolefin film layer in facing relationship with the composite blend layer.

A third particular aspect includes the first and/or second aspect, wherein the water-soluble synthetic thermoplastic polymer is polyvinyl alcohol (PVOH), and wherein the PVOH is partially hydrolyzed, fully hydrolyzed, or a blend of both.

A fourth particular aspect includes one or more of aspects 1-3, wherein the nanoclay particles or talc particles are nanoclay particles.

A fifth particular aspect includes one or more of aspects 1-4, wherein the nanoclay particles have a particle size between 10 and 15 microns.

A sixth particular aspect includes one or more of aspects 1-5, wherein the nanoclay particles or talc particles are talc particles.

A seventh particular aspect includes one or more of aspects 1-6, wherein the talc particles have a particle size between 3 and 10 microns.

An eighth particular aspect includes one or more of aspects 1-7, wherein the nanoclay particles or talc particles are nanoclay particles and talc particles.

A ninth particular aspect includes one or more of aspects 1-8, further including a polyolefin inner layer, wherein the composite blend layer is disposed between the polyolefin inner layer and the polyolefin film layer.

A tenth particular aspect includes one or more of aspects 1-9, wherein the polyolefin inner layer is polyethylene or a thermoplastic polyurethane.

In an eleventh particular aspect, a laminate film consists of two layers, wherein the first layer is a composite blend layer including polyvinyl alcohol (PVOH) and blocking particles, wherein the blocking particles are nanoclay particles or talc particles, and wherein the second layer is a polyolefin film layer in facing relationship with the composite blend layer, wherein the laminate is free of compatibilizers.

A twelfth particular aspect includes the eleventh particular aspect, further consisting of a polyolefin inner layer in facing relationship with the composite blend layer, wherein the composite blend layer is disposed between the polyolefin inner layer and the second layer.

In a thirteenth particular aspect, a solvent-resistant glove includes a composite film, the composite film including a composite blend layer including PVOH and blocking particles, wherein the blocking particles are nanoclay particles or talc particles; and a polyolefin film layer in facing relationship with the composite blend layer to form a laminate film, wherein the laminate film is free of compatibilizers.

A fourteenth particular aspect includes the thirteenth particular aspect, further including a polyolefin film layer additive to improve grip.

A fifteenth particular aspect includes the thirteenth and/or fourteenth aspect, wherein the polyolefin film layer includes one or more of an embossed surface, calcium carbonate, and talc.

A sixteenth particular aspect includes one or more of aspects 13-15, further including a polyolefin inner layer, wherein the composite blend layer is disposed between the polyolefin inner layer and the polyolefin film layer to form a film laminate.

A seventeenth particular aspect includes one or more of aspects 13-16, the glove having an interior surface comprising an interior surface additive to improve donning.

An eighteenth particular aspect includes one or more of aspects 13-17, wherein the interior surface additive is one or more of a slip agent, calcium carbonate, and talc.

These and other modifications and variations to the present disclosure can be practiced by those of ordinary skill in the art, without departing from the spirit and scope of the present disclosure, which is more particularly set forth in the appended claims. In addition, it should be understood that elements of the various aspects can be interchanged both in whole and in part. Furthermore, those of ordinary skill in the art will appreciate that the foregoing description is by way of example only, and is not intended to limit the disclosure so further described in such appended claims.

What is claimed:

1. A composite film comprising:
a composite blend layer including a water-soluble synthetic thermoplastic polymer and blocking particles, wherein the blocking particles are nanoclay particles or talc particles, and wherein the composite film is free of compatibilizers.

2. The composite film of claim 1, further comprising a polyolefin film layer in facing relationship with the composite blend layer.

3. The composite film of claim 2, wherein the water-soluble synthetic thermoplastic polymer is polyvinyl alcohol (PVOH), and wherein the PVOH is partially hydrolyzed, fully hydrolyzed, or a blend of both.

4. The composite film of claim 1, wherein the nanoclay particles or talc particles are nanoclay particles.

5. The composite film of claim 4, wherein the nanoclay particles have a particle size between 10 and 15 microns.

6. The composite film of claim 1, wherein the nanoclay particles or talc particles are talc particles.

7. The composite film of claim 6, wherein the talc particles have a particle size between 3 and 10 microns.

8. The composite film of claim 1, wherein the nanoclay particles or talc particles are nanoclay particles and talc particles.

9. The composite film of claim 1, further comprising a polyolefin inner layer, wherein the composite blend layer is disposed between the polyolefin inner layer and the polyolefin film layer.

10. The composite film of claim 9, wherein the polyolefin inner layer is polyethylene or a thermoplastic polyurethane.

11. A laminate film consisting of two layers, wherein the first layer is a composite blend layer including polyvinyl alcohol (PVOH) and blocking particles, wherein the blocking particles are nanoclay particles or talc particles, and wherein the second layer is a polyolefin film layer in facing relationship with the composite blend layer, wherein the laminate is free of compatibilizers.

12. The laminate film of claim 11, further consisting of a polyolefin inner layer in facing relationship with the composite blend layer, wherein the composite blend layer is disposed between the polyolefin inner layer and the second layer.

13. A solvent-resistant glove comprising:
a composite film, the composite film comprising:
a composite blend layer including PVOH and blocking particles, wherein the blocking particles are nanoclay particles or talc particles; and
a polyolefin film layer in facing relationship with the composite blend layer to form a laminate film, wherein the laminate film is free of compatibilizers.

14. The glove of claim 13, further comprising a polyolefin film layer additive to improve grip.

15. The glove of claim 13, wherein the polyolefin film layer includes one or more of an embossed surface, calcium carbonate, and talc.

16. The glove of claim 13, further comprising a polyolefin inner layer, wherein the composite blend layer is disposed between the polyolefin inner layer and the polyolefin film layer to form a film laminate.

17. The glove of claim 13, the glove having an interior surface comprising an interior surface additive to improve donning.

18. The glove of claim 17, wherein the interior surface additive is one or more of a slip agent, calcium carbonate, and talc.
